(19) United States
(12) Patent Application Publication
(10) Pub. No.: US 2025/0178205 A1
(43) Pub. Date: Jun. 5, 2025

(54) ROBOT SYSTEM, METHOD OF CONTROLLING THE ROBOT SYSTEM, METHOD OF MANUFACTURING PRODUCTS, AND RECORDING MEDIUM

(71) Applicant: CANON KABUSHIKI KAISHA, Tokyo (JP)

(72) Inventors: AKIHIRO ODA, Kanagawa (JP); YUICHIRO KUDO, Kanagawa (JP); MOTOHIRO HORIUCHI, Kanagawa (JP)

(21) Appl. No.: 18/963,019

(22) Filed: Nov. 27, 2024

(30) Foreign Application Priority Data
Dec. 4, 2023 (JP) 2023-204873
Sep. 26, 2024 (JP) 2024-167897

(51) Int. Cl. B25J 9/16

(52) U.S. Cl. CPC B25J 9/1694

(57) ABSTRACT

A robot system includes a robot, a search unit configured to search a work area of a workpiece where work is performed and obtain search data that contains information on the work area, at least one processor, and at least one memory that is in communication with the at least one processor. The at least one memory stores instructions for causing the at least one processor and the at least one memory to identify the work area and control the robot for causing the robot to perform work on the identified work area, based on information related to the work area, information on work related to the work area and performed on the workpiece, and the search data.

### BACKGROUND

### Technical Field Disclosure

The present disclosure relates to a robot apparatus, a robot system, an information processing apparatus, a method of controlling the robot apparatus, a method of controlling the robot system, a method of manufacturing products, a program, and a recording medium.

### Description of the Related Art

Robot apparatuses, such as industrial robots, disposed in a factory or the like perform various types of work, such as assembling or attaching a component to a workpiece, applying adhesive or paint onto a workpiece, and machining a workpiece by using a tool. Such work can be performed precisely (accurately) on a workpiece, regardless of the position and posture of the workpiece, by using a camera or the like and recognizing the image of a portion of the workpiece on which the work is to be performed, and by controlling the position and posture of the robot with respect to the portion of the workpiece which has been recognized. However, in a case where such precise work is performed by a robot apparatus, a heavy load for adjusting the robot apparatus will be put on a worker when the robot apparatus is installed in a factory or when the work or the workpiece is changed. For example, in a method that uses the template matching in image recognition, the adjustment for the image-processing process, which corrects brightness and extracts features for example, is performed for increasing the matching accuracy between a template image and a captured image. However, since the adjustment is complicated, it takes time for a worker to set conditions. As a result, a load will be put on the worker.

For this reason, Japanese Patent Application Publication No. 2020-197983 proposes a technique for calculating the position and angle of a workpiece. In this technique, a captured image of a workpiece is inputted into a learned learner, so that two or more partially extracted images are obtained. The partially extracted images are subjected to the blob analysis, so that the blob information is created. The position and angle of the workpiece is calculated from the blob information. Thus, the technique proposed by Japanese Patent Application Publication No. 2020-197983 reduces the above-described load of the adjustment work performed for the image-processing process.

In addition, in a study described in “Recognition of Function of Objects and its Application to Robot Manipulation” (Manabu Hashimoto, Journal of the Robotics Society of Japan, Vol. 38, No. 6, pp. 525-529, 2020), a function (affordance) of an object is focused, and a system for creating a learned model that three-dimensionally recognizes an area that represents the function is proposed. The system is intended to identify a three-dimensional work area for a robot manipulator by using the learned model and cause the robot manipulator to hold and transfer a workpiece.

### SUMMARY

Thus, embodiments of the present disclosure aim to reduce the load of a worker.

According to a first aspect of the present disclosure, a robot system includes a robot, a search unit configured to search a work area of a workpiece where work is performed and obtain search data that contains information on the work area, at least one processor, and at least one memory that is in communication with the at least one processor, wherein the at least one memory stores instructions for causing the at least one processor and the at least one memory to identify the work area and control the robot to perform work on the identified work area, based on information related to the work area, information on work related to the work area and performed on the workpiece, and the search data.

According to a second aspect of the present disclosure, a method of controlling a robot system that includes a robot, a search unit for probing a work area of a workpiece where work is performed, at least one processor, and at least one memory, includes obtaining, by the search unit, search data that contains information on the work area, and identifying, by the at least one processor and the at least one memory, the work area and controlling the robot to perform work on the identified work area, based on information related to the work area, information on work related to the work area and performed on the workpiece, and the search data.

Further features of various embodiments will become apparent from the following description of exemplary embodiments with reference to the attached drawings.

### BRIEF DESCRIPTION OF THE DRAWINGS

FIG. 1 is a diagram illustrating a configuration of a robot system of a first embodiment.

FIG. 2 is a block diagram illustrating a configuration of an information processing apparatus of the first embodiment.

FIG. 3 is a block diagram illustrating a configuration of a robot controller of the first embodiment.

FIG. 4 is a flowchart illustrating processes of assembly work performed by the robot system of the first embodiment.

FIG. 5 is a perspective view illustrating one example of a CAD model of a workpiece.

FIG. 6 is a perspective view illustrating one example of a labeling portion of the workpiece.

FIG. 7 is a perspective view illustrating one example of a label model into which the labeling portion is modeled.

FIG. 8 is a diagram illustrating one example of label model information to which assembly information is given.

FIG. 9 is a diagram illustrating a state where an image of the CAD model is captured by a virtual camera in a virtual space.

FIG. 10A is a diagram illustrating one example of a virtual CAD-model image obtained by the virtual camera capturing an image of the CAD model.

FIG. 10B is a diagram illustrating one example of a virtual region-model image obtained by the virtual camera capturing an image of the label model.

FIG. 11 is a diagram illustrating a learning process for learning the image features of the labeling portion.

FIG. 12 is a diagram illustrating an inference process for inferring the labeling portion from actual image data.

FIG. 13 is a diagram illustrating a process for computing the position of the labeling portion in a camera coordinate system.

FIG. 14 is a diagram illustrating a process for computing the position of the labeling portion in a robot coordinate system.

FIG. 15 is a diagram illustrating a configuration of a robot system of a second embodiment.

FIG. 16 is a flowchart illustrating processes of assembly work performed by a robot apparatus of the second embodiment.

FIG. 17 is a diagram illustrating a process for creating a three-dimensional point group image.

FIG. 18 is a diagram illustrating a process for defining a solid angle of a workpiece of

a third embodiment.

FIG. 19 is a diagram illustrating a learning process for learning the image features of a labeling portion of the third embodiment while associating the image features with a solid angle of the workpiece.

FIG. 20 is a diagram illustrating one example of a GUI that shows a result of model matching of a fifth embodiment.

FIGS. 21A-B are diagrams illustrating position-and-posture information of a CAD model 22 that corresponds to a labeling portion 21 of an actual workpiece 10 of a sixth embodiment.

FIG. 22 is a diagram illustrating a configuration of a robot apparatus of the sixth embodiment.

FIG. 23 is a control block diagram for illustrating control performed by using visual servo of a seventh embodiment.

FIGS. 24A-B are diagrams for illustrating a method of creating image data that corresponds to target features of the seventh embodiment.

FIG. 25 is a flowchart illustrating processes of assembly work performed by a robot apparatus of the seventh embodiment.

### DESCRIPTION OF THE EMBODIMENTS

In Japanese Patent Application Publication No. 2020-197983, although the technique can measure the position and angle of a workpiece on a two-dimensional plane, it is difficult to calculate the three-dimensional position-and-posture information of a workpiece from the blob information. Thus, it may be difficult to automatically create the trajectory of the robot for the motion for the work, and thus it may take time to create (teach) the trajectory of the robot. As a result, a load may be put on a worker for the adjustment work of the robot.

In addition, although the technique described in the above-described “Recognition of Function of Objects and its Application to Robot Manipulation” can be applied to a type of work for which a robot is roughly moved, it is difficult to be applied to a type of work for which a robot is required to perform precise work (with high recognition accuracy). That is, even in a case where the above-described technique is used, it is necessary, in precise assembly work or the like, to set a precise operation (trajectory) of a robot arm performed on a work area of a workpiece that has been recognized by the technique. Since the setting is required to be performed by a worker who has specialized knowledge, a heavy load will be put on the worker also in this case.

### First Embodiment

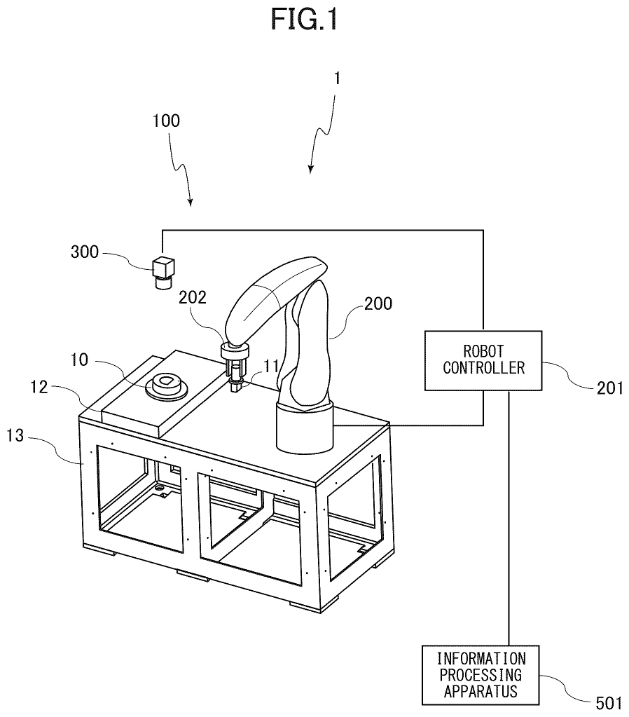

Hereinafter, a first embodiment for embodying the present disclosure will be described with reference to FIGS. 1 to 14.

### Schematic Configuration of Robot System

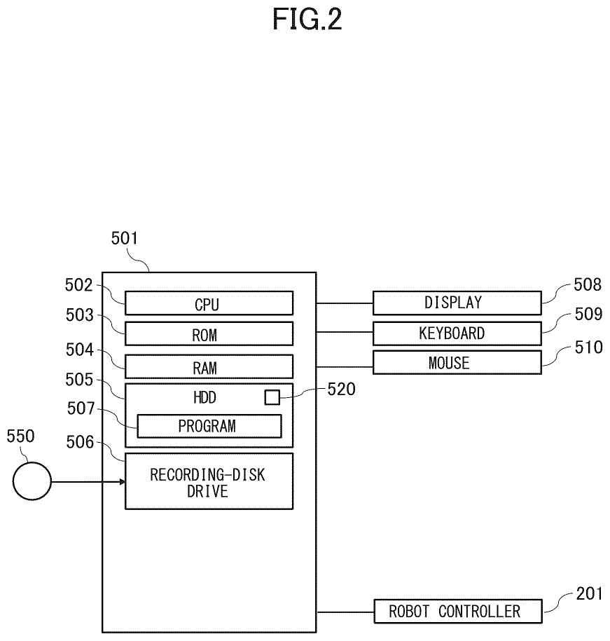

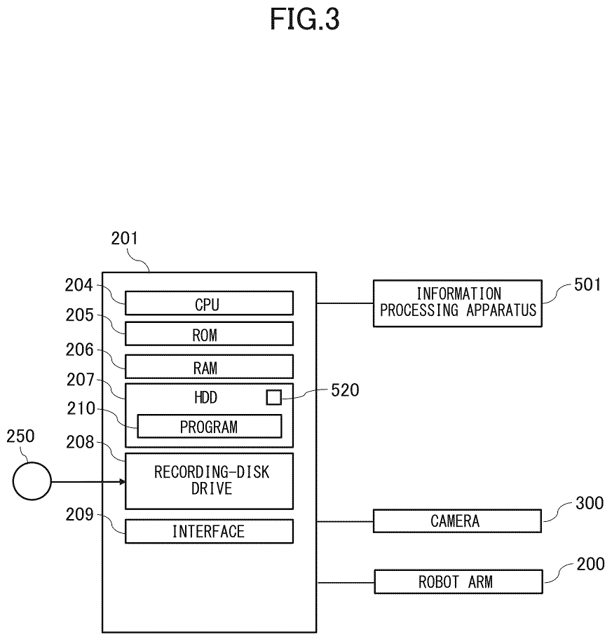

First, a schematic configuration of a robot system of the first embodiment will be described with reference to FIGS. 1, 2, and 3. FIG. 1 is a diagram illustrating a configuration of the robot system of the first embodiment. FIG. 2 is a block diagram illustrating a configuration of an information processing apparatus of the first embodiment. FIG. 3 is a block diagram illustrating a configuration of a robot controller of the first embodiment.

A robot system 1 is an automatic assembling system that assembles a component 11 that serves as an assembling workpiece for example, to a workpiece 10 that serves as an assembled workpiece. The robot system 1 mainly includes a robot apparatus 100 and an information processing apparatus 501. The robot apparatus 100 is fixed to and supported by a stand 13, and includes a robot arm (manipulator) 200 that serves as a robot, and a robot controller 201 that controls the robot arm 200.

In addition, the robot apparatus 100 includes a robot hand 202 attached to a distal end of the robot arm 200 and serving as an end effector that holds (holds) the component 11. The shape and structure of the robot hand 202 is not limited to a specific shape and structure as long as the robot hand 202 can hold the component 11. For example, the robot hand 202 may have a structure that applies suction to the component 11. In another case, the robot hand 202 may include a force sensor or the like, if necessary.

The workpiece 10 is placed on a workpiece stand 12 disposed on the stand 13. The robot apparatus 100 includes a camera 300 serving as a search unit or an image capture apparatus and disposed above the workpiece stand 12 or the workpiece 10. The camera 300 captures the image of an image capture area (image capture range) that at least includes the workpiece 10, and obtains the image as the image data of an actual image. The camera 300 may be a two-dimensional camera that has a function to output two-dimensional image data, or may be a three-dimensional camera, such as a stereo camera, that has a function to output three-dimensional image data. Note that in the present embodiment, the description will be made for a case where the camera 300 is a fixed camera that is, for example, disposed on a ceiling of a factory. However, the camera 300 may be an on-hand camera fixed to the robot hand 202, if the on-hand camera can capture the image of the image capture area that includes the workpiece 10. That is, the camera may be disposed on the robot apparatus 100, which serves as a robot. The image data captured by the camera 300 is sent to the robot controller 201, and is subjected to information processing as described in detail below. The information processing means calculating command values (e.g., a trajectory of the robot arm) by the robot controller 201, for controlling the robot for assembling the component 11 to the workpiece 10.

The robot system 1 configured as described above performs assembly work in which the component 11 held by the robot hand 202 of the robot apparatus 100 is assembled to a hole portion of the workpiece 10 that is a work area described in detail below. In this manner, the robot system 1 manufactures the workpiece 10 (to which the component 11 is assembled), as a product, by using the robot apparatus 100 and performing the assembly work in which the component 11 is assembled to the workpiece 10. In other words, the robot system 1 uses the robot apparatus 100 and performs a method of manufacturing the product in which the component 11 is assembled to the workpiece 10.

### Configuration of Information Processing Apparatus

Next, a configuration of the information processing apparatus 501 will be described with reference to FIG. 2. As illustrated in FIG. 2, the information processing apparatus 501 includes a central processing unit (CPU) 502 that is one example of processors. The CPU 502 is one example of a processing unit. In addition, the information processing apparatus 501 includes a read only memory (ROM) 503, a random access memory (RAM) 504, and a hard disk drive (HDD) 505, which serve as storage units. In addition, the information processing apparatus 501 includes a recording-disk drive 506, a display 508, a keyboard 509, and a mouse 510. The display 508 serves as a display apparatus that is an input/output interface. The CPU 502, the ROM 503, the RAM 504, the HDD 505, the recording-disk drive 506, the display 508, the keyboard 509, and the mouse 510 are communicatively connected with each other via a bus.

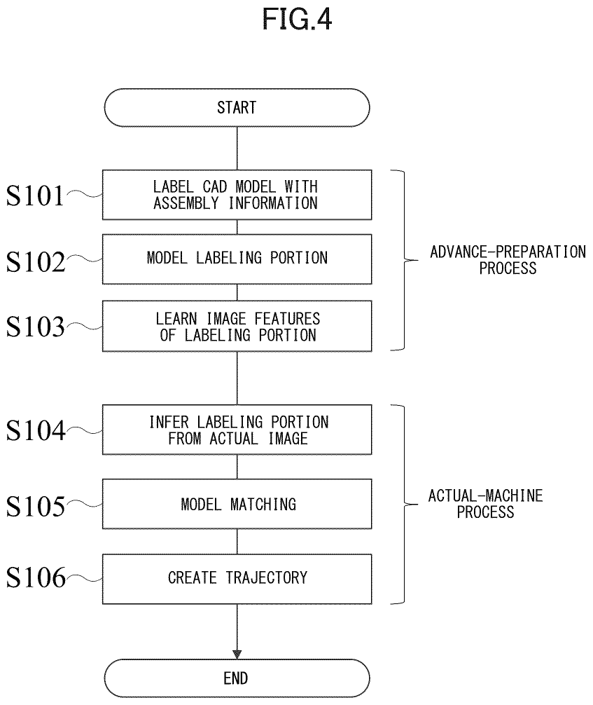

The ROM 503 stores a base program related to the operation of the computer. The RAM 504 is a storage device that temporarily stores various types of data, such as results of a computing process performed by the CPU 502. The HDD 505 stores various types of data, such as results of a computing process performed by the CPU 502 and data obtained from an external device, and a program 507 that causes the CPU 502 to execute various types of processes described below. The program 507 is application software that allows the CPU 502 to execute various types of processes related to a below-described advance-preparation process (FIG. 4). Thus, the CPU 502 can execute various types of processes of the below-described advance-preparation process by executing the program 507 stored in the HDD 505. In addition, the HDD 505 includes an area in which learning-model information 520 is stored. The learning-model information 520 is model information obtained from execution results of various types of processes of the below-described advance-preparation process. The recording-disk drive 506 reads various types of data and a program stored in a recording disk 550.

In the present embodiment, the HDD 505 is a computer-readable non-transitory recording medium, and stores the program 507. However, some embodiments of the present disclosure are not limited to this. The program 507 may be stored in any recording medium as long as the recording medium is a computer-readable non-transitory recording medium. For example, a flexible disk, a hard disk, an optical disk, a magneto-optical disk, a magnetic tape, a nonvolatile memory, or the like may be used as the recording medium that provides the program 507 to the computer.

The information processing apparatus 501 is connected with the robot controller 201. As described in detail below, the information processing apparatus 501 sends the learning-model information 520 to the robot controller 201, as a processing result obtained by executing various types of processes of the advance-preparation process.

### Configuration of Robot Controller

Next, a configuration of the robot controller 201 will be described with reference to FIG. 3. As illustrated in FIG. 3, the robot controller 201 includes a CPU 204 that is one example of processors. The CPU 204 is one example of a processing unit. The robot controller 201 also includes a ROM 205, a RAM 206, and an HDD 207, which serve as storage units. The robot controller 201 also includes a recording-disk drive 208, and an interface 209 that is an input/output interface. The CPU 204, the ROM 205, the RAM 206, the HDD 207, the recording-disk drive 208, and the interface 209 are communicatively connected with each other via a bus.

The ROM 205 stores a base program related to the operation of the computer. The RAM 206 is a storage device that temporarily stores various types of data, such as results of a computing process performed by the CPU 204. The HDD 207 stores various types of data, such as results of a computing process performed by the CPU 204 and data obtained from an external device, and a program 210 that causes the CPU 204 to execute various types of processes related to a below-described actual-machine process (see FIG. 4). The program 210 is application software that allows the CPU 204 to execute various types of processes related to the below-described actual-machine process. Thus, the CPU 204 can control the motion of the robot arm 200 by executing the control process by executing the program 210 stored in the HDD 207. In addition, the HDD 207 includes an area in which the learning-model information 520 sent from the above-described information processing apparatus 501 is stored. The recording-disk drive 208 reads various types of data and a program stored in a recording disk 250.

In the present embodiment, the HDD 207 is a computer-readable non-transitory recording medium, and stores the program 210. However, some embodiments of the present disclosure are not limited to this. The program 210 may be stored in any recording medium as long as the recording medium is a computer-readable non-transitory recording medium. For example, a flexible disk, a hard disk, an optical disk, a magneto-optical disk, a magnetic tape, a nonvolatile memory, or the like may be used as the recording medium that provides the program 210 to the computer.

The robot controller 201 is connected with the camera 300, the robot arm 200, and the above-described information processing apparatus 501. As described in detail below, the robot controller 201 receives the learning-model information 520 sent from the information processing apparatus 501. The learning-model information 520 is a processing result obtained by executing various types of processes of the advance-preparation process. The camera 300 captures image data, and sends the image data to the robot controller 201. The image data is processed by the program 210. The processing result is outputted as a command value for controlling the robot, and sent to the robot arm 200.

Note that although the description will be made, in the present embodiment, for a case where the advance-preparation process (see FIG. 4) is executed by the information processing apparatus 501 (i.e., the CPU 502) and the actual-machine process (see FIG. 4) is executed by the robot controller 201 (i.e., the CPU 204), some embodiments of the present disclosure are not limited to this. The advance-preparation process and the actual-machine process may be executed by a single computer or a single CPU, or may be executed by three or more computers or three or more CPUs. In addition, in a case where the processes of the advance-preparation process and the actual-machine process (see FIG. 4) are assigned to and executed by a plurality of computers, any process may be executed by any computer.

### Processes of Assembly Work

Next, processes of assembly work by a robot (i.e., control of the robot system) for performing the assembly work (as illustrated in FIG. 1) in the above-described robot system 1 will be described with reference to FIGS. 4 to 14.

### Advance-Preparation Process

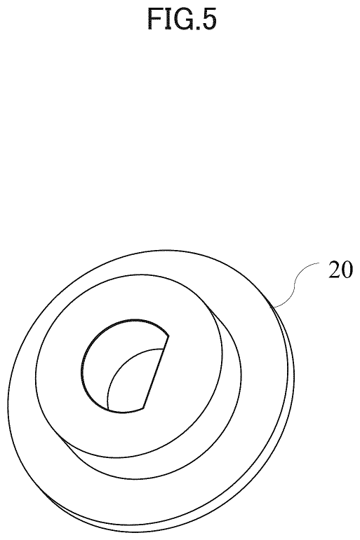

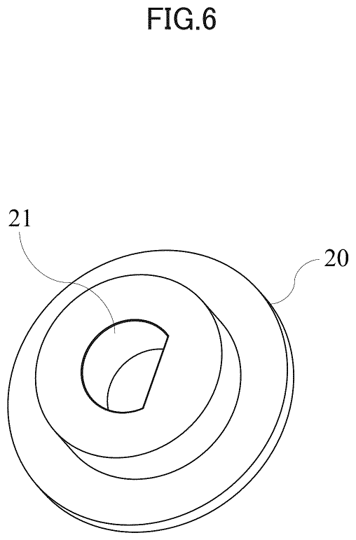

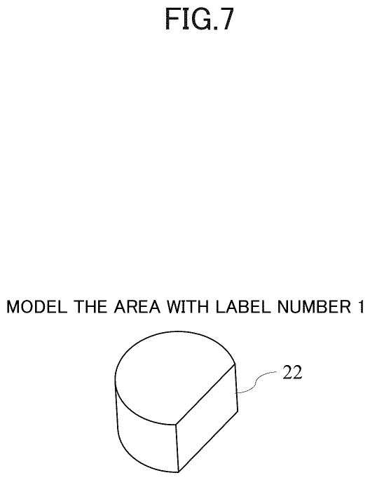

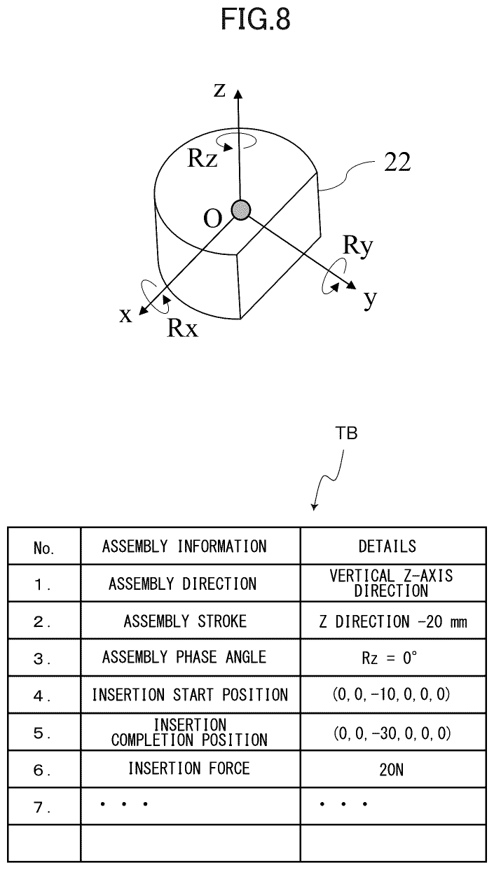

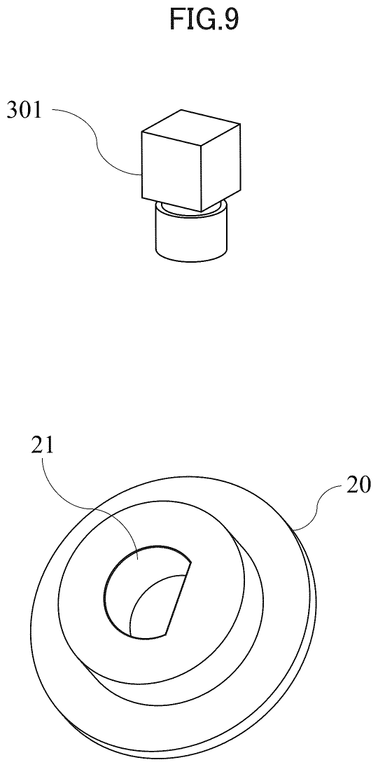

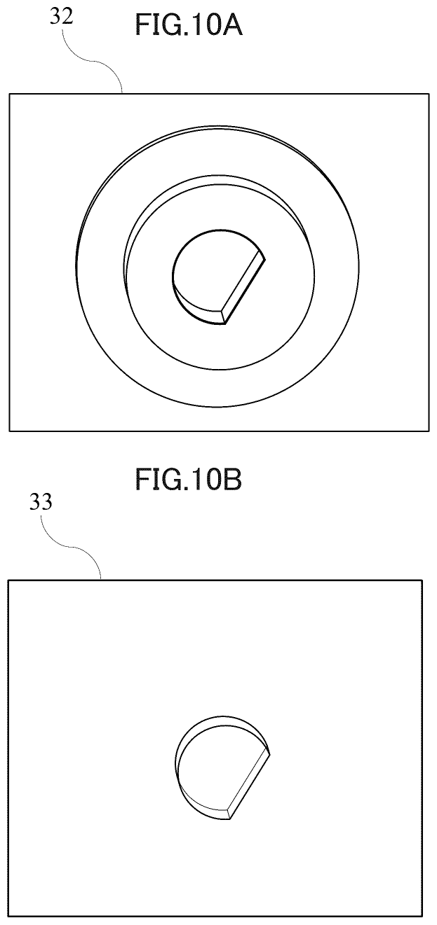

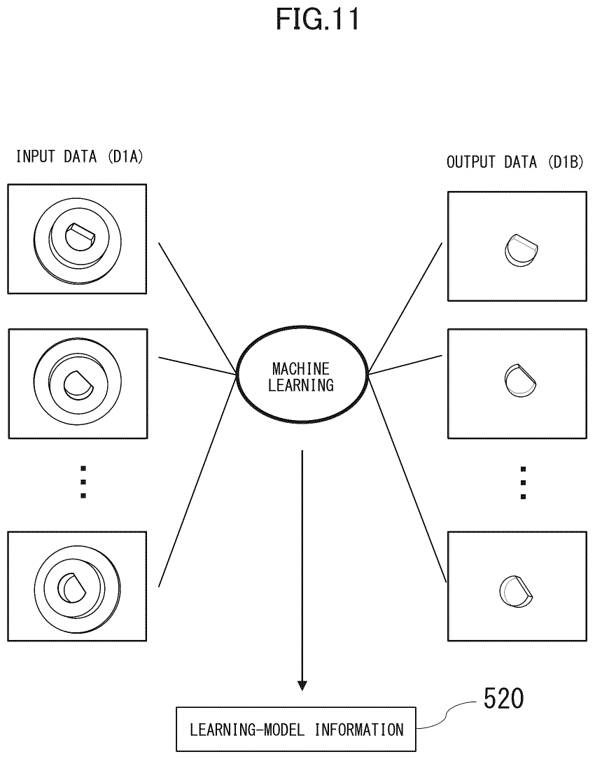

First, the advance-preparation process executed by the above-described information processing apparatus 501 will be described with reference to FIGS. 4 to 11. FIG. 4 is a flowchart illustrating processes of assembly work performed by the robot system of the first embodiment. FIG. 5 is a perspective view illustrating one example of a CAD model of a workpiece. FIG. 6 is a perspective view illustrating one example of a labeling portion of the workpiece. FIG. 7 is a perspective view illustrating one example of a label model into which the labeling portion is modeled. FIG. 8 is a diagram illustrating one example of label model information to which assembly information is given. FIG. 9 is a diagram illustrating a state where an image of the CAD model is captured by a virtual camera in a virtual space. FIG. 10A is a diagram illustrating one example of a virtual CAD-model image obtained by the virtual camera capturing an image of the CAD model. FIG. 10B is a diagram illustrating one example of a virtual region-model image obtained by the virtual camera capturing an image of the label model. FIG. 11 is a diagram illustrating a learning process for learning image features of the labeling portion.

As illustrated in FIG. 4, the advance-preparation process performed in the steps S101 to S103 is a process for advance preparation performed before the robot apparatus 100 is actually operated (that is, before the actual assembly work is performed). The advance-preparation process is a process for creating the learning-model information 520 by using a computer-aided design tool, such as a computer-aided design (CAD) system. That is, as described in detail below, the advance-preparation process creates the learning-model information 520 by using CAD data of the workpiece 10 that is design information used when the workpiece 10 is designed.

In Step S101, the CPU 502 performs work (hereinafter referred to as labeling work) on a CAD model of the workpiece 10, on a computer-aided design tool such as a CAD system. The CAD model has a data representation format that the computer-aided design tool can handle. In general, some formats, such as the STEP file, the IGES file, and the STL file, are known. In the labeling work, a work area of a CAD model 20 illustrated in FIG. 5 and corresponding to the workpiece 10 is identified, and the work area is labeled. The work area is an area which the component 11 is brought into contact with and assembled to. The label is, for example, an identification number that identifies a work area of the CAD model 20 that corresponds to a portion to which the component 11 is assembled. For example, the data that represents a label number of 1 is added to a labeled work area. By performing the above-described process, a labeling portion 21 that corresponds to the labeled work area is created as illustrated in FIG. 6. Note that in this process, if the workpiece 10 has a plurality of work areas with which other components or workpieces are brought into contact, the plurality of work areas may be labeled, and a plurality of labeling portions may be formed. The labeling portions may be provided with label numbers of 2, 3, . . . for distinguishing the labeling portions from each other.

In Step S102, the CPU 502 performs the modeling of the labeling portion 21. As illustrated in FIG. 7, in the modeling of the labeling portion 21, the work area labeled in Step S101, that is, the labeling portion 21 to which the data that represents, for example, a label number of 1 has been added is modeled into a CAD model 22 that is a new three-dimensional model. The CAD model 22 can be expressed by the above-described format, such as STEP, IGES, or STL; and represents the information related to the work area in the present embodiment.

As illustrated in FIG. 8, the CAD model 22 of the labeled work area is given assembly information that is information on assembly work (that is, the assembly information is associated with the CAD model 22, and stored in the HDD 505). The assembly information is work information on the work that is to be performed on the work area. For giving the assembly information to the CAD model 22, the CAD model 22 has a coordinate system O that is disposed at a predetermined position, and that serves as a reference. The coordinate system O has axes x, y, and z that are orthogonal to each other and that represent a three-dimensional Euclidean space, and rotation components Rx, Ry, and Rz that are components around the respective axes. Thus, the position and posture in the three-dimensional space can be expressed in the six-axis coordinate system of the robot apparatus 100. Note that although the description has been made, as an example in the present embodiment, for the Cartesian coordinate space, the coordinate system O may have another system, such as the polar coordinate system or the quaternion, as long as the position and posture in the three-dimensional space can be expressed in the coordinate system O.

Then, as illustrated in a table of FIG. 8, table data TB that represents assembly information (i.e., work information) is created. The table data TB contains various types of data on the assembly work (operation, function), such as the information that represents an assembly direction in which a component is assembled to a workpiece, and the information on the assembly stroke from a contact point to a point at which the assembling is completed. In addition, the table data TB also contains the information on the assembly phase angle that represents an orientation of a component assembled to a workpiece, the information on the insertion start position and the insertion completion position of a component assembled to a workpiece, and an insertion force necessary for assembling a component to a workpiece. In this manner, the CAD model 22 and the table data TB are stored, associated with each other on a one-to-one basis (that is, the CAD model 22 and the table data TB are associated with each other, and stored in the HDD 505). Note that if the workpiece 10 has a plurality of labeled work areas as described above, a plurality of CAD models that correspond to the plurality of labeled work areas may be created, and each of the plurality of CAD models may be provided with corresponding table data TB on a one-to-one basis.

In Step S103, the CPU 502 learns the image features of the labeling portion. In Step S103, as illustrated in FIG. 9, a virtual camera 301 that corresponds to the camera 300 illustrated in FIG. 1 is created and used in a virtual space of a computer-aided design tool, such as a CAD system. In addition, an image of the three-dimensional CAD model 20 corresponding to the workpiece 10 and viewed from the virtual camera 301 is captured.

Preferably, the setting of the virtual camera 301 is made equal to the setting of the camera 300 actually used by the robot system 1. For example, the cell size of the image capture apparatus, the number of pixels, the focal length of the lens, the aperture of the virtual camera 301, and the like are made equal to those of the camera 300. With the setting performed in this manner, the virtual camera 301 can capture an image 32 (hereinafter referred to as a virtual image) of the CAD model in the virtual space of the computer-aided design tool, as illustrated in FIG. 10A. Since it is difficult to obtain the same shade and texture information of the workpiece 10 as those of an actual image, these types of information are not necessarily required. The minimum necessary information is the information on outline that represents the shape of the workpiece 10. Preferably, the outline information is equal to the outline of the CAD model 20.

Then the three-dimensional CAD model 22 of the work area is disposed in the virtual space of the computer-aided design tool. The work area is labeled so that the position of the work area is equal to the position of the labeling portion 21 of the CAD model 20 of the workpiece 10. After that, an image of the CAD model 22 of the labeling portion 21 is captured by the virtual camera 301, so that a virtual image 33 as illustrated in FIG. 10B is obtained. The virtual image 33 is image data from which the outline information of the CAD model 22 of the labeling portion 21 can be obtained. Then the virtual image 32 illustrated in FIG. 10A and the virtual image 33 illustrated in FIG. 10B are stored so as to form a pair (that is, the virtual image 32 and the virtual image 33 are associated with each other, and stored in the HDD 505).

Note that it is necessary that at least one pair of the image data be obtained for the below-described learning. However, if more virtual images having different image capture angles and different brightness levels are obtained, it may be more preferable. For obtaining a plurality of virtual images, the brightness of the virtual images and/or the texture of the workpiece 10 may be changed unless the outline information is lost. In addition, in capturing images of the CAD model 20, the relative position between the virtual camera 301 and the CAD model 20 of the workpiece 10, or the relative position between the virtual camera 301 and the CAD model 22 of the labeling portion 21 may be changed in a possible range. The possible range is a range in which the camera 300 and the workpiece 10 may be shifted from each other in the positional relationship thereof, in the actual robot system 1.

The pairs of image data of a plurality of virtual images obtained in the above-described process are used in a learning process as illustrated in FIG. 11. For example, the learning is performed while each of pairs of virtual images having different image capture angles and different brightness levels is associated with the above-described table data TB (see FIG. 8). In the present embodiment, a machine-learning algorithm is used in the learning process. In particular, among the algorithms of machine learning, an algorithm of supervised learning is used. Thus, the image data of the plurality of virtual images obtained in advance is training data D1 used for the supervised learning. Of the training data D1, the virtual image obtained by capturing the image of the CAD model 20 of the workpiece 10 is input data DIA, and the virtual image obtained by capturing the image of the CAD model 22 of the labeling portion 21 is output data D1B. The machine learning is performed such that the input data D1A and the output data D1B are associated with each other. As a result, the learning-model information 520 is created as a learned model (creation process).

The algorithm of machine learning used in Step S103 may be the semantic segmentation or the instance segmentation. Each of the semantic segmentation and the instance segmentation is one type of supervised learning, and is an algorithm that infers an output value for each pixel of the input data DIA, by performing the machine learning based on the training data D1. If the learning is performed well, the outline information of the CAD model 22 of the labeling portion 21 can be obtained from the input data DIA. Note that the algorithm used for the machine learning is not limited to the semantic segmentation or the instance segmentation, and may be another algorithm other than the semantic segmentation and the instance segmentation if the other algorithm has a function to extract the above-described features. In Step S103, the learning-model information 520 obtained by performing the learning is stored, for example, in the HDD 505 that serves as a storage unit of the information processing apparatus 501. In addition, the learning-model information 520 is outputted so as to be transferred, for example, to the HDD 207 that serves as a storage unit of the robot controller 201; and is used for the below-described actual-machine process.

### Actual-Machine Process

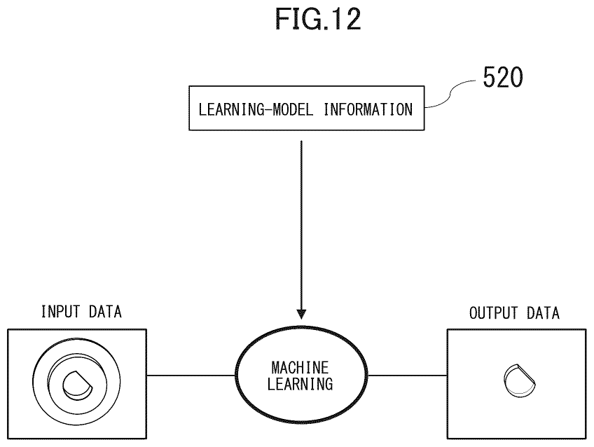

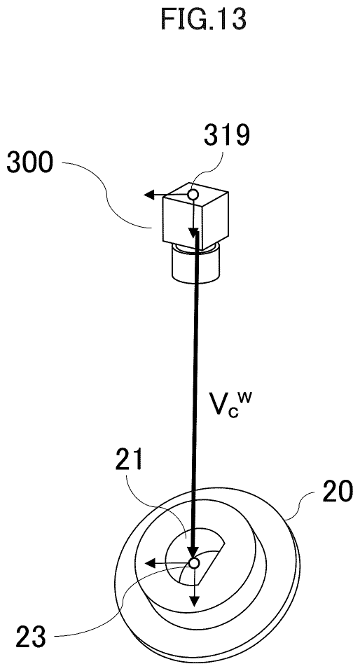

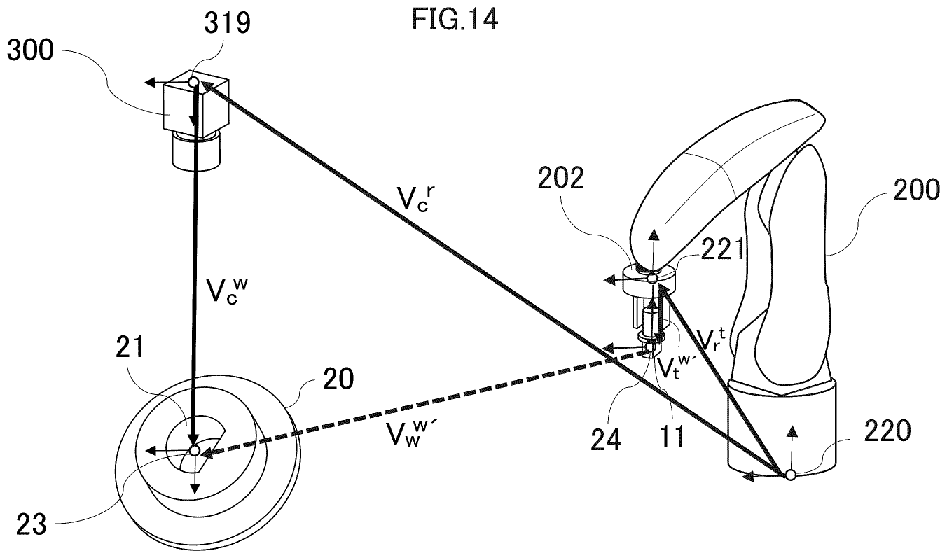

Next, an actual-machine process executed by the robot controller 201 will be described with reference to FIGS. 4, 12, 13, and 14. FIG. 12 is a diagram illustrating an inference process for inferring the labeling portion from actual image data. FIG. 13 is a diagram illustrating a process for computing the position of the labeling portion in a camera coordinate system. FIG. 14 is a diagram illustrating a process for computing the position of the labeling portion in a robot coordinate system.

As illustrated in FIG. 4, the actual-machine process performed in steps S104 to S106 is a process for operating the robot apparatus 100 (that is, for performing the actual assembly work). In Step S104, the CPU 204 infers the labeling portion 21 from an actual image. Specifically, in a state where the workpiece 10 is placed on the workpiece stand 12 (see FIG. 1), the camera 300 captures an image of an area (i.e., an image capture range) that contains the workpiece 10. Note that the camera 300 functions as a search unit that searches a work area of the workpiece 10 where the work is performed, and that obtains search data that contains information on the work area. The image data of the actual image captured as search data is transferred to the robot controller 201, and is used, as illustrated in FIG. 12, for an inference process performed in the machine learning. Note that in a case where the image of the workpiece 10 placed on the workpiece stand 12 is captured by the camera 300, the camera 300 is moved to a position above the workpiece 10, and the posture of the camera 300 is controlled by the robot arm 200 so that the image capture direction of the camera 300 faces the workpiece 10. For example, the trajectory of the robot arm 200 used in this case is a trajectory into which a worker teaches, in advance, the robot arm 200 the posture and position by using a teaching pendant or the like.

The input data illustrated in FIG. 12 is the image data of an actual image captured by the camera 300. The CPU 204 infers the output data by reading the above-described learning-model information 520, and by using the same algorithm of machine learning as the algorithm used in the learning. If the learning-model information 520 is learning-model information of a learned model that has learned well, the output data becomes image data (hereinafter referred to as inference image) that corresponds to the outline information of the CAD model 22 of the labeling portion 21.

In Step S105, the CPU 204 performs a model matching process on the inference image obtained in Step S104. In the matching process, the CAD model 22 of the labeling portion 21 created in Step S102 is used. In this manner, the position and posture of the work area of the workpiece 10 is substantially identified in the image data of the actual image captured by the camera 300. That is, in Step S105, the work area is identified by using the learning-model information 520, the image data, and the CAD model 22 of the labeling portion 21 (identification process).

Note that the image used in the matching process in Step S105 may be the inference image itself obtained in Step S104. However, a portion of the captured image data that corresponds to the area (i.e., a matching area) obtained by performing the inference may be extracted, then an area of the image data other than the above-described portion may be determined as a mask area that is subjected to a mask process, and then the matching process may be performed on image data in which the mask area has been subjected to the mask process. In short, the matching process may be performed on the learning-model information 520 and the image data in which the mask area has been subjected to the mask process. In this manner, the load of the image processing can be reduced.

As illustrated in FIG. 13, if the matching is completed well, a vector Vc^{w} of the labeling portion 21 viewed from the camera can be determined by also using a known camera calibration technique. The vector Vc^{w} is positional information of the CAD model 22 in the three-dimensional space. Note that the vector Vc^{w} extends from an origin 319 of the camera coordinate system to an origin 23 of a coordinate system O that serves as a reference of a CAD model of any labeling portion.

In Step S106, the CPU 204 creates a trajectory for causing the robot arm 200 to assemble the component 11 to the workpiece 10 in a state where the robot arm 200 holds (grasps) the component 11. Specifically, as illustrated in FIG. 14, first, the CPU 204 determines a vector Vc^{w} from an origin 220 of a coordinate system of the robot arm 200 to the origin 319 of the camera coordinate system by using a known hand-eye calibration technique. In addition, since the robot arm 200 holds the component 11 via the robot hand 202, the CPU 204 determines the vector from the origin 220 of the coordinate system of the robot arm 200 to a predetermined reference position 24 of the component 11, as a vector Vr^{t}×Vt^{w′}.

Note that the vector Vr^{t} extends from the origin 220 of the coordinate system of the robot arm 200 to an origin 221 of the coordinate system of the robot hand 202. The vector Vr^{t} may be calculated by using any one of various known methods. For example, the vector Vr^{t} may be calculated by using a value from an encoder that detects the angle of a corresponding joint. The value from the encoder is used for the robot arm 200 to calculate the position of the robot arm 200. In another case, the vector Vr^{t} may be determined by measuring the position of the robot hand from, for example, an image captured by a camera disposed outside. The vector Vt^{w′} extends from the origin 221 of the coordinate system of the robot hand 202 to the predetermined reference position 24 of the component 11. The vector Vt^{w′} may also be calculated by using any one of various known methods. That is, the vector Vt^{w′} may be determined by performing the measurement from the outside, or may be positioned mechanically.

In this manner, the CPU 204 creates a trajectory Vw^{w′} for the robot arm 200 to move the component 11 to the labeling portion 21 of the workpiece 10. That is, the robot arm 200 moves the component 11 on the trajectory Vw^{w′} until the assembling of the component 11 to the workpiece 10 is started. The trajectory Vw^{w′} is not limited to a straight trajectory, and may be any trajectory as long as the start point and the end point are not changed. For example, the path between the start point and the end point may be subjected to any interpolation process, such as the spline interpolation.

In addition, based on the assembly information (see FIG. 8) contained in the above-described learning-model information 520, the CPU 204 creates a trajectory from a position at which the assembling of the component 11 to the workpiece 10 is started (the insertion is started), to a position at which the assembling is completed (the insertion is completed). The above-described table data TB contains information on the assembly direction, the assembly stroke, the assembly phase angle, the insertion start position, the insertion completion position, the insertion force, and the like, as the information on the work performed on a workpiece. Thus, the CPU 204 uses the information, and creates the trajectory for assembling the component 11 to the workpiece 10, from the assembly start position. Then, the CPU 204 creates the trajectory for controlling the robot arm 200 in the assembly work, by adding the trajectory for assembling the component 11 to the workpiece 10, to the trajectory Vw^{w′} determined as described above and used for moving the component 11 until the assembling of the component 11 to the workpiece 10 is started. Note that the information on the work performed on a workpiece has only to contain at least one of the assembly direction of a component, the assembly stroke for assembling the component, the assembly phase angle of the component, the insertion start position of the component, the insertion completion position of the component, and the insertion force for the component.

After creating the trajectory, in Step S106, for controlling the robot arm 200 in the assembly work, the CPU 204 outputs the trajectory, as a command value, to the robot arm 200, and drives the robot arm 200 so that the robot arm 200 moves on the trajectory. In this manner, the component 11 is moved, based on the assembly information contained in the learning-model information 520 (see FIG. 8), to the identified work area of the workpiece 10 by the robot arm 200, and is assembled to the workpiece 10 while the position and posture of the component 11 is controlled. That is, in Step S106, the robot arm 200 is controlled so that the work is performed on the work area identified in Step S105 (work process).

### Summary of First Embodiment

As described above, by causing the robot system 1 to perform the processes of the assembly work illustrated in FIG. 4, the component 11 can be automatically assembled to the work area of the workpiece 10 by the robot apparatus 100, without applying heavy load to a worker for the adjustment work.

Specifically, in the present embodiment, in the processes in Step S101 to Step S102, the workpiece 10 is modeled into the CAD model 20 in the virtual space of a CAD system. This operation can significantly reduce the work that has been conventionally performed for the advance preparation. For example, the work for producing many template images by using the camera 300 and capturing images of the workpiece 10 while changing the image capture angle can be significantly reduced, and the adjustment work for the image-processing process that, for example, performs focus correction and extracts features can be significantly reduced. Thus, the load of the adjustment work to a worker can be reduced.

In addition, in the present embodiment, not only the CAD model 20 into which the whole of the workpiece 10 is modeled, but also the CAD model 22 of the labeling portion 21 labeled as a work area is created. Thus, in the model matching process in Step S105, the amount of computation can be significantly reduced and the speed can be increased, in comparison with a case where the matching process is performed on the CAD model 20 which is a model of the whole of the workpiece 10. In addition, the model matching process is performed not on a two-dimensional template image and an actual image, but on the three-dimensional CAD model 22 and an actual image. Thus, the position and posture of the workpiece 10 can be determined three-dimensionally from the learning-model information 520.

In addition, in the present embodiment, the image features of the labeling portion 21 are learned in the process of Step S103. With this operation, the number of images of the CAD model 20 captured by the virtual camera 301 in the virtual space can be reduced in comparison with a case where many template images are prepared. Thus, the load of the advance-preparation process can be reduced, and the load of the adjustment work performed by a worker can be reduced. Furthermore, since the learning-model information 520 that is information on the learned model is created, the accuracy of the inference for the labeling portion 21 and of the model matching, performed in the steps S104 to S105, can be increased.

In addition, in the present embodiment, the CAD model 22 and the table data TB are stored in the learning-model information 520 such that the CAD model 22 of the labeling portion 21 is associated with the table data TB that is assembly information obtained from the CAD data (design information). Thus, in a case where the trajectory of the robot arm 200 is created in Step S106, the trajectory of the robot arm 200 can be automatically created with high accuracy, by extracting the table data TB associated with the CAD model 22 which, together with an actual image, has been subjected to the matching process. As a result, the assembly work of the robot apparatus 100 can be performed with high accuracy. In addition, since the assembly information obtained from the CAD data (design information) is used, it is not necessary for a worker to prepare many trajectories, in advance, created in accordance with angles of a workpiece. As a result, the load of the adjustment work performed by the worker can be reduced.

As described above, by causing the robot system 1 of the present embodiment to perform the process of assembly work, the load of the adjustment work, which is advance preparation, can be reduced, and the automatic production system that performs the assembly work by using the robot apparatus 100 can be started in a short time.

Note that in the first embodiment, the description has been made for the case where the CAD model 22 of the labeling portion 21 is created and the matching is performed on the CAD model 22 and an actual image in the model matching process. However, some embodiments of the present disclosure are not limited to this. For example, the CAD model 20 of the workpiece 10 may be created, and the matching may be performed on the CAD model 20 and an actual image.

In addition, in the first embodiment, for identifying the modeled labeling portion 21 from an actual image, the learning is performed in the steps S103 and S104, by using an algorithm of machine learning. However, some embodiments of the present disclosure are not limited to this. For example, the labeling portion 21 may be identified by using a method other than the learning.

### Second Embodiment

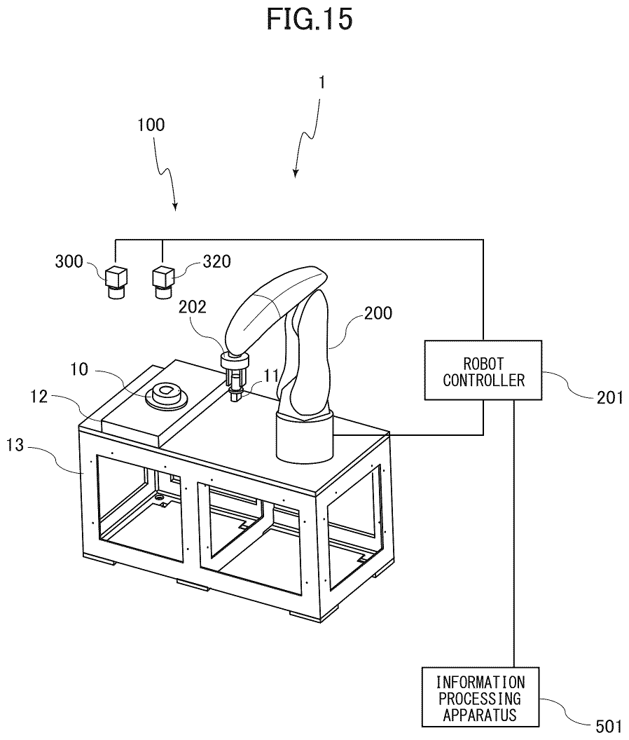

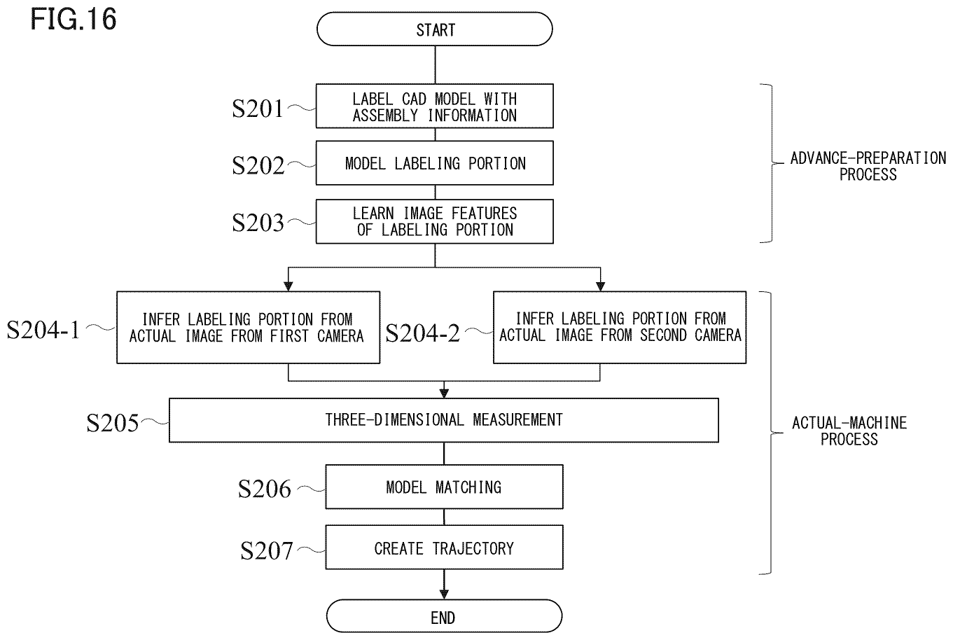

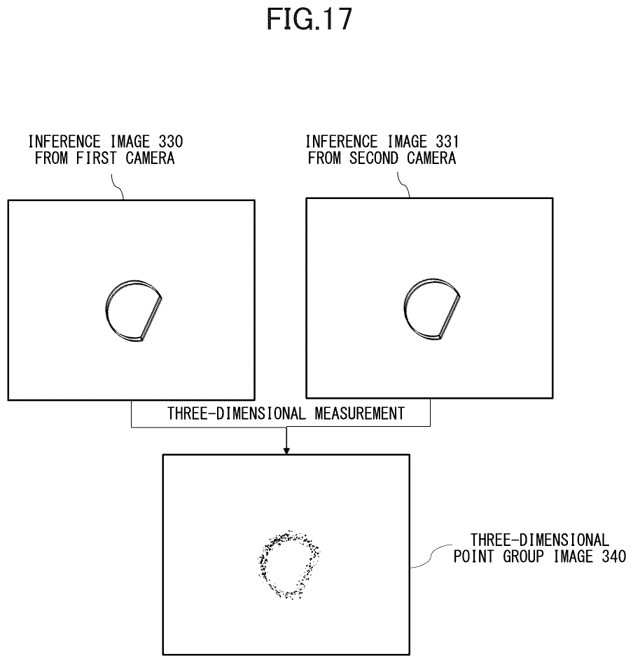

Next, a second embodiment will be described with reference to FIGS. 15 to 17. In the second embodiment, part of the above-described first embodiment is changed. FIG. 15 is a diagram illustrating a configuration of a robot system of the second embodiment. FIG. 16 is a flowchart illustrating processes of assembly work performed by a robot apparatus of the second embodiment. FIG. 17 is a diagram illustrating a process for creating a three-dimensional point group image. Note that in the description for the second embodiment, a component identical to a component of the above-described first embodiment is given an identical symbol, and the description thereof will be omitted.

### Configuration of Robot System of Second Embodiment

As illustrated in FIG. 15, a robot system 1 of the second embodiment includes a second camera 320 in addition to the camera 300 (hereinafter referred to as a first camera). The second camera 320 serves as a search unit or an image capture apparatus. The first camera 300 and the second camera 320 constitute a stereo camera, and three-dimensionally measure the actual workpiece 10. Note that in the robot system 1 illustrated in FIG. 15, the first camera 300 and the second camera 320 are fixed cameras, as one example. However, the first camera 300 and the second camera 320 may be on-hand cameras mounted on the robot hand 202. In addition, the number of cameras that serve as image capture apparatuses is not limited to two, and may be three or more. For example, the robot system 1 may include both of a fixed camera and an on-hand camera, and one or both of the fixed camera and the on-hand camera may be a stereo camera constituted by two cameras.

### Processes of Assembly Work of Second Embodiment

Next, processes of assembly work performed by the robot system 1 of the second embodiment will be described. As illustrated in FIG. 16, the steps S201, S202, and S203 that are the advance-preparation process performed before the robot apparatus 100 is actually operated are the same as the above-described steps S101, S102, and S103 illustrated in FIG. 4. However, in the learning in Step S203, the learning-model information 520 may be created from virtual images of the CAD model 22 captured by the first camera 300 and the second camera 320 arranged virtually. In another case, the common learning-model information 520 may be created. In a case where the common learning-model information 520 is created, the input data D1A includes image data of the CAD model 22 captured by both of the first camera 300 and the second camera 320 arranged virtually.

Next, an actual-machine process performed in the processes of assembly work of the second embodiment will be described. In the second embodiment, after the actual-machine process is started, the CPU 204 causes the first camera 300 and the second camera 320 to capture images of the workpiece 10 in the steps S204-1 and S204-2. Then the CPU 204 infers the labeling portion 21 from the image data captured by the first camera 300 and the image data captured by the second camera 320. In this case, the learning-model information 520 dedicated to the image data captured by the first camera 300 and the learning-model information 520 dedicated to the image data captured by the second camera 320 may be used, or the common learning-model information 520 may be used, as described above. Anyway, the labeling portion 21 is inferred from the image data captured by the first camera and the image data captured by the second camera 320.

In Step S205, the CPU 204 performs three-dimensional measurement. The three-dimensional measurement can be performed by using the principle of triangulation, by performing the known stereo calibration on the first camera 300 and the second camera 320. That is, as illustrated in FIG. 17, based on an inference image 330 from the first camera 300 and an inference image 331 from the second camera 320, a three-dimensional point group image 340 can be obtained by performing the three-dimensional measurement by using a known method, such as block matching. In Step S206, the model matching process is performed on the three-dimensional point group image 340 and the labeling portion 21. With this operation, the position and posture of the labeling portion 21 and the assembly information (see the table data TB in FIG. 8) can be obtained. After obtaining the position and posture of the labeling portion 21 and the assembly information, the CPU 204 creates the trajectory in Step S207. The process of creating the trajectory is the same as the above-described process of Step S106. In this manner, the CPU 204 creates the trajectory of the robot arm 200.

Note that the image used for performing the three-dimensional measurement in Step S205 may be the inference image itself obtained in Step S204. However, a portion of the captured image data that corresponds to the area (i.e., a matching area) obtained by performing the inference may be extracted, then an area of the image data other than the above-described portion may be determined as a mask area that is subjected to a mask process, and then the three-dimensional measurement may be performed on the image data in which the mask area has been subjected to the mask process. That is, the CPU 204 may obtain the three-dimensional point group image 340 from the image data in which the mask area has been subjected to the mask process, and may perform the model matching process on the three-dimensional point group image 340 and the labeling portion 21. In short, in a broad sense, the matching process may be performed on the learning-model information 520 and the image data in which the mask area has been subjected to the mask process. In this manner, the load of the image processing can be reduced.

In addition, the matching process may be performed after the preprocessing is performed on the inference image 330 from the camera 300 and the inference image 331 from the camera 320. In the preprocessing, the noise generated by performing the inference may be removed, and the linear approximation or the ellipse approximation may be performed.

### Summary of Second Embodiment

As described above, in the process of the assembly work performed by the robot system 1 of the second embodiment, the inference image 330 and the inference image 331 are obtained by the first camera 300 and the second camera 320, which constitute a stereo camera. Then the three-dimensional point group image 340 is created from the inference images, and the model matching process is performed on the three-dimensional point group image 340. In this manner, the work area of the actual workpiece 10 can be identified with high accuracy.

Note that since other configurations, operations, and effects of the second embodiment are the same as those of the above-described first embodiment, the description thereof will be omitted.

### Third Embodiment

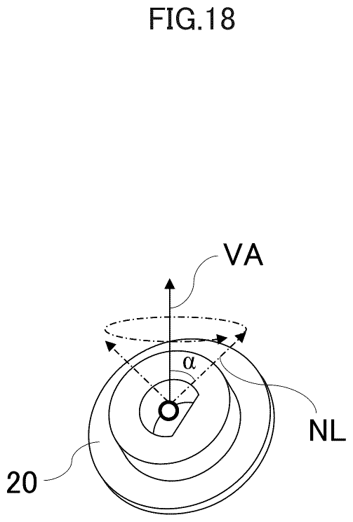

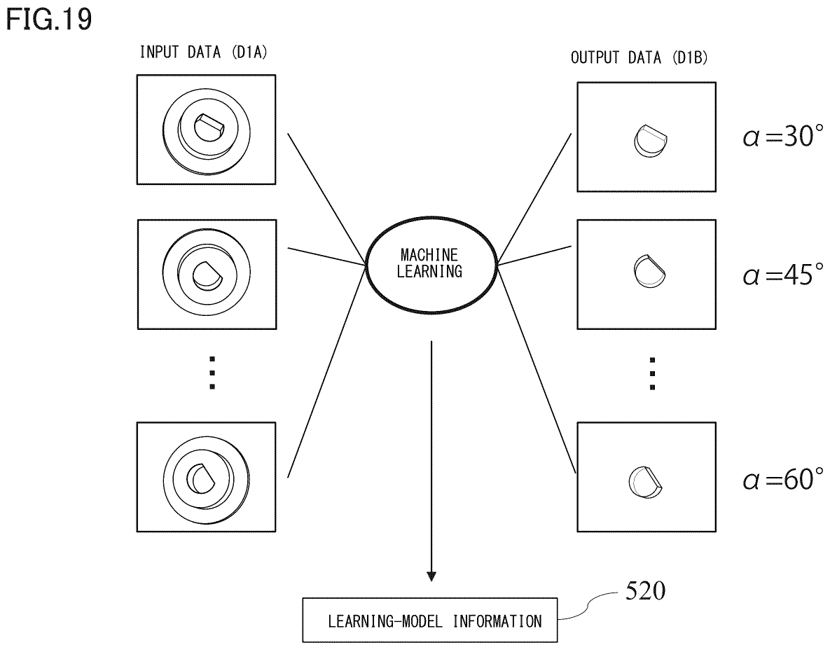

Next, a third embodiment will be described with reference to FIGS. 18 to 19. In the third embodiment, part of the above-described first and second embodiments is changed. FIG. 18 is a diagram illustrating a process for defining a solid angle of a workpiece of the third embodiment. FIG. 19 is a diagram illustrating a learning process for learning the image features of a labeling portion of the third embodiment while associating the image features with a solid angle of the workpiece. Note that also in the description for the third embodiment, a component identical to a component of the above-described first and second embodiments is given an identical symbol, and the description thereof will be omitted.

In the third embodiment, when the CPU 502 learns the image features of the labeling portion 21 in the above-described Step S103, the CPU 502 learns the posture information in addition to the position of outlines of the CAD model 20 of the workpiece 10. Specifically, as illustrated in FIG. 18, a solid angle α is defined, as posture information, with respect to a reference vector VA that is set in the CAD model 20 in the virtual space. The solid angle α represents which direction a normal line NL to the CAD model 20 faces. That is, the solid angle α is defined for the posture of each of a plurality of CAD models 20 whose images are captured by the virtual camera 301 in the virtual space and which have different image capture angles. The solid angle α is associated with each CAD model 20, and the solid angle α and the corresponding CAD model 20 are contained in the learning-model information 520, as the posture information.

That is, as illustrated in FIG. 19, the CPU 502 learns the output data D1B while associating the output data D1B with the value of the solid angle α. For performing the learning in this manner, the CPU 502 tags the output data D1B with the information of the solid angle α (posture information), and performs the learning by using an algorithm, such as the above-described instance segmentation. If the learning is performed well, the CPU 502 infers also the solid angle α when inferring the labeling portion 21 in Step S104. Thus, when performing the model matching process in the next step S105, the CPU 502 can perform the matching on images having limited angles, for example. As a result, the risk of mismatching can be reduced.

Note that since other configurations, operations, and effects of the third embodiment are the same as those of the above-described first and second embodiments, the description thereof will be omitted.

### Fourth Embodiment

Next, a fourth embodiment will be described. In the fourth embodiment, part of the above-described first to third embodiments is changed. Note that also in the description for the fourth embodiment, a component identical to a component of the above-described first to third embodiments is given an identical symbol, and the description thereof will be omitted.

In the fourth embodiment, in a case where the trajectory of the robot arm 200 is created in the above-described step S106, objects other than the labeling portion 21 are modeled for creating the trajectory on which the robot arm 200 does not interfere with the workpiece 10 itself and any surrounding objects other than the workpiece 10. That is, in Step S102 as an example, a surrounding model is created from the CAD data, by modeling not only the labeling portion 21 (work area), which is a portion to which the component 11 is assembled, but also surrounding objects disposed in and around the workpiece 10. Then the surrounding-model information that is the information on the surrounding models is created. Note that the models other than the labeling portion 21 may not be associated with the table data TB as illustrated in FIG. 8. The procedures other than the above-described procedure are the same as those in the above-described process of assembly work (see FIG. 4). In this manner, the CPU 502 creates the surrounding model of surrounding objects other than the labeling portion 21, performs the model matching process, determines a trajectory on which the robot arm 200 does not interfere with the surrounding objects (surrounding model), and creates the trajectory of the robot arm 200, based on the trajectory that the CPU 502 has determined. In this manner, when the CPU 502 creates the trajectory of the robot arm 200, the CPU 502 can create the trajectory of the robot arm 200 on which the robot arm 200 does not interfere with the workpiece 10 and the surrounding objects around the workpiece 10.

Note that since other configurations, operations, and effects of the fourth embodiment are the same as those of the above-described first to third embodiments, the description thereof will be omitted.

### Fifth Embodiment

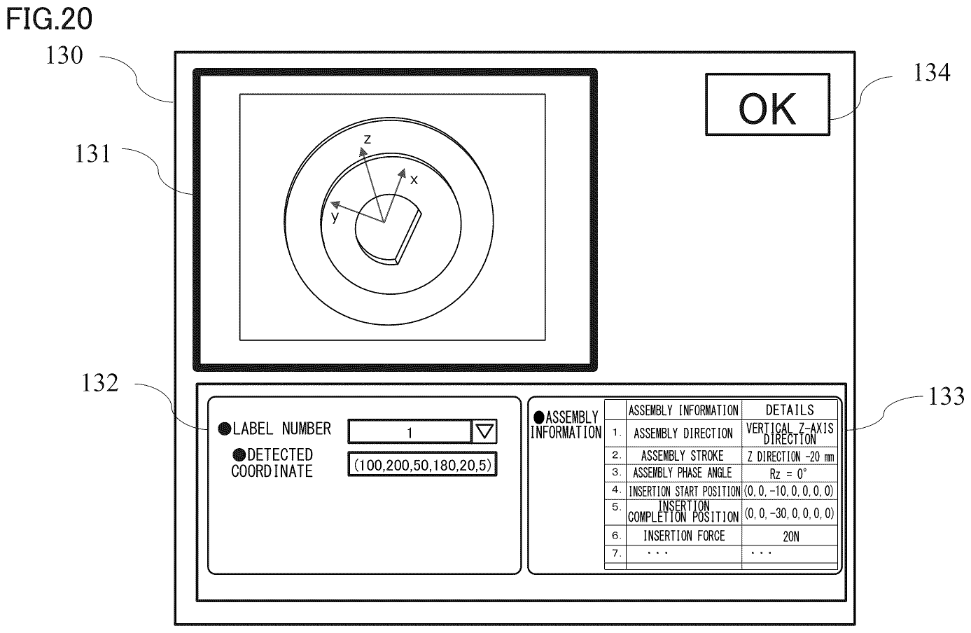

Next, a fifth embodiment will be described with reference to FIG. 20. In the fifth embodiment, part of the above-described first to fourth embodiments is changed. FIG. 20 is a diagram illustrating one example of a GUI that shows a result of model matching of the fifth embodiment. Note that also in the description for the fifth embodiment, a component identical to a component of the above-described first to fourth embodiments is given an identical symbol, and the description thereof will be omitted.

In the fifth embodiment, the progress in the processes of assembly work illustrated in FIG. 4 is displayed as a graphical user interface (GUI) 130. For example, the GUI 130 may be displayed on a display apparatus, such as the display 508 connected to the information processing apparatus 501. In the present embodiment, the description will be made, as an example, for a case where the CPU 204 of the robot controller 201 creates the GUI 130 and transfers the GUI 130 to the information processing apparatus 501, and where the display 508 displays the GUI 130. However, some embodiments of the present disclosure are not limited to this. For example, the CPU 204 may create the GUI 130, and may transfer the GUI 130 to a display apparatus directly connected to the robot controller 201. In another case, the CPU 204 of the robot controller 201 may calculate various types of data and transfer the data to the information processing apparatus 501, and the CPU 502 may create the GUI 130 and cause the display 508 to display the GUI 130.

One example of the GUI 130 will be described with reference to FIG. 20. The GUI 130 includes a main window 131 that displays an image captured in the above-described step S104, a result of inference performed in the above-described step S104, and a result of matching performed in Step S105. In addition, the label number obtained by performing the labeling in Step S101 can be checked in a label information window 132. The processing result corresponding to the label number selected in the label information window 132 is displayed in the main window 131. If the model matching process is performed well in Step S105, the reference coordinate of the CAD model 22 of the labeling portion 21, as illustrated in FIG. 8, is displayed in the label information window 132, as a detected coordinate. In a detection result window 134, letters such as “OK” are displayed if the detection has been performed successfully, or letters such as “NG” are displayed if the detection has failed. In an assembly information window 133, the table data TB as illustrated in FIG. 8 and representing the assembly information corresponding to the label number of the labeling portion 21 is displayed. Since the GUI 130 is displayed as described above, a user can determine whether the workpiece 10 or the work area of the workpiece 10 has been detected successfully.

Note that since other configurations, operations, and effects of the fifth embodiment are the same as those of the above-described first to fourth embodiments, the description thereof will be omitted.

### Sixth Embodiment

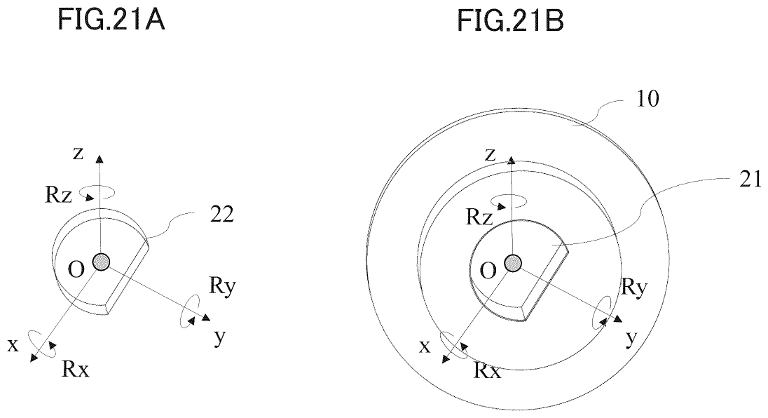

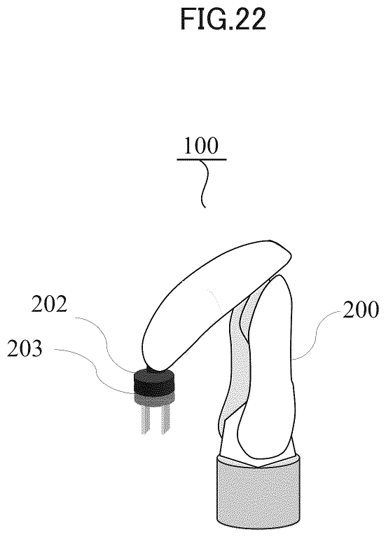

Next, a sixth embodiment will be described with reference to FIGS. 21A to 22. FIGS. 21A and 21B are diagrams illustrating position-and-posture information of a CAD model 22 that corresponds to a labeling portion 21 of an actual workpiece 10 of the sixth embodiment. FIG. 22 is a diagram illustrating a robot apparatus 100 of the sixth embodiment. Note that in the description for the sixth embodiment, a component identical to a component of the above-described various embodiments is given an identical symbol, and the description thereof will be omitted. In the present embodiment, the robot apparatus 100 performs the assembly work without using any assembly information, such as the table data TB described in the above-described embodiments, as table information. The control flow of the present embodiment is basically performed in accordance with the process flow illustrated in FIG. 4, but differs in the method of creating the trajectory performed in Step S106 of FIG. 4.

The CPU 204 performs the model matching in Step S105 of the process flow illustrated in FIG. 4, and obtains the position-and-posture information of the CAD model 22, as illustrated in FIGS. 21A-B, that corresponds to the labeling portion 21 of the actual workpiece 10. The CPU 204 obtains the position-and-posture information, based on the coordinate system O. FIG. 21A illustrates the position-and-posture information based on the coordinate system O of the CAD model 22 that corresponds to the labeling portion 21 of the actual workpiece 10. FIG. 21B illustrates the workpiece 10. Based on this information, the CPU 204 moves the robot apparatus 100 to the assembly position. In this case, the method of creating the trajectory for moving the robot apparatus 100 and the coordinate transformation method are the same as those described with reference to FIG. 14. In a case where the assembly information, such as the table data TB, is not used, the assembly direction is required to be determined in advance. The assembly stroke, the phase angle, the insertion start position, and the insertion completion position are detected, after the robot apparatus 100 is moved to the assembly position, by a force sensor 203 attached to the robot hand 202 as illustrated in FIG. 22.

The force sensor 203 detects the external force or moment applied from the outside, separately in the six-axis directions; and allows the straight movement of the robot arm 200 until sensing a predetermined level of force in each direction. In another case, a known technique, such as the admittance control or the impedance control performed based on the measured external force, may be used until the assembly operation is completed by the robot arm 200.

The assembly direction is determined, in advance, in the program for moving the robot so that the component can be moved toward a designated direction based on the obtained position-and-posture information of the CAD model 22. For example, in a case where the position-and-posture information as illustrated in FIGS. 21A-B is obtained based on the actual workpiece 10, the designated direction is a vertical Z-axis direction in the coordinate system O of the CAD model 22. That is, the component is moved toward a −Z-axis direction in the coordinate system O of the CAD model 22. The position-and-posture information illustrated in FIGS. 21A-B is the same as the position-and-posture information illustrated in FIG. 8. However, the coordinate system O illustrated in FIGS. 21A-B is different in expression from the coordinate system O illustrated in FIG. 8, for convenience of description. Since the position-and-posture information based on the coordinate system O as illustrate in FIGS. 21A-B is obtained, based on the actual workpiece 10 in Step S105 illustrated in FIG. 4, the designated direction with respect to the coordinate system O is set, in advance, in the program, as the assembly direction. Thus, even if the position and posture of the actual workpiece 10, to which the component is to be assembled, varies, the position-and-posture information of the CAD model 22 that corresponds to the workpiece 10 whose position and posture has varied can be obtained in the coordinate system O. As a result, the component 11 can be moved toward the direction in which the component 11 is assembled to the workpiece 10.

The CPU 204 obtains the information on the force applied to the force sensor 203 while the component 11 is moved toward the assembly direction. In addition, the CPU 204 sets a predetermined value, in advance, as a threshold value for determining the completion of the assembling. If the CPU 204 detects that the information on the force has reached the predetermined value, the CPU 204 determines the completion of the assembling, and completes the assembly operation. In a case where the clearance between the workpiece 10 and the component 11 is formed with high accuracy, the position of the component 11, moved by the robot arm 200, may be adjusted in a state where the component 11 is in contact with the workpiece 10, for making the phase of the component 11 equal to the phase of the workpiece 10. In this case, the CPU 204 detects the information on the force applied to the force sensor 203 while the position of the component 11 is adjusted. If the force value becomes equal to the predetermined value, the CPU 204 determines that the phase of the component 11 has become equal to the phase of the workpiece 10, and moves the component 11 toward the assembly direction. In this manner, even if a clearance is formed between workpieces with high accuracy, one workpiece can be assembled to the other.

As described above, in the present embodiment, the position-and-posture information is obtained in the coordinate system O of the actual workpiece 10 without using the table data TB, so that the component 11 can be assembled to the workpiece 10. In this configuration, the number of parameters that are set in advance in the assembly process, which uses the robot apparatus 100, can be reduced. As a result, the load of the advance preparation can be further reduced. In addition, the automatic production system that performs the assembly work by using the robot apparatus 100 can be started in a short time.

### Seventh Embodiment

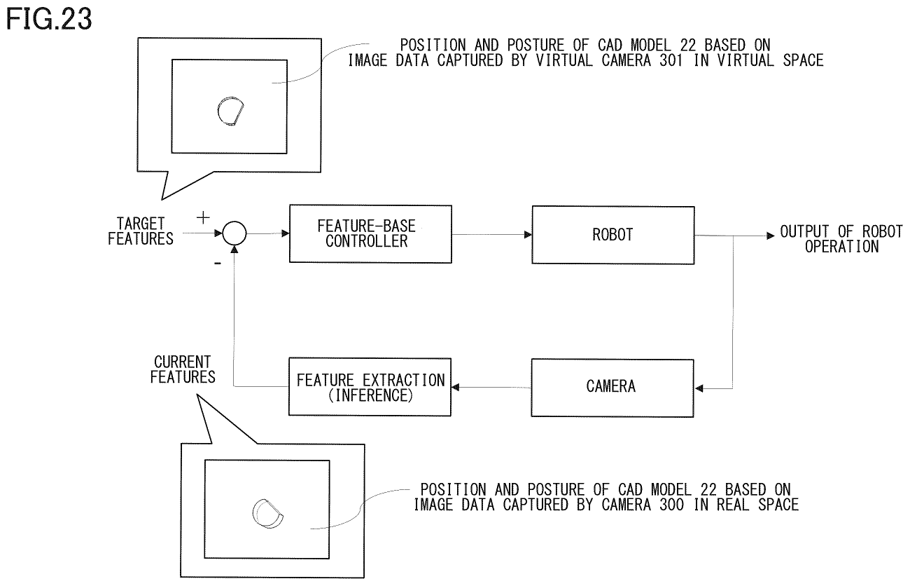

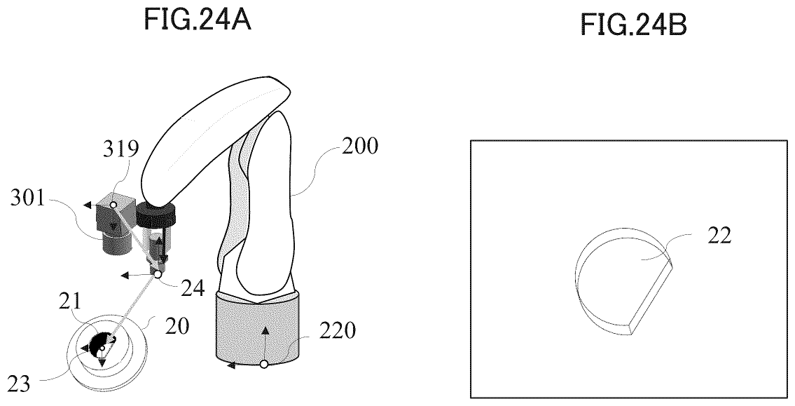

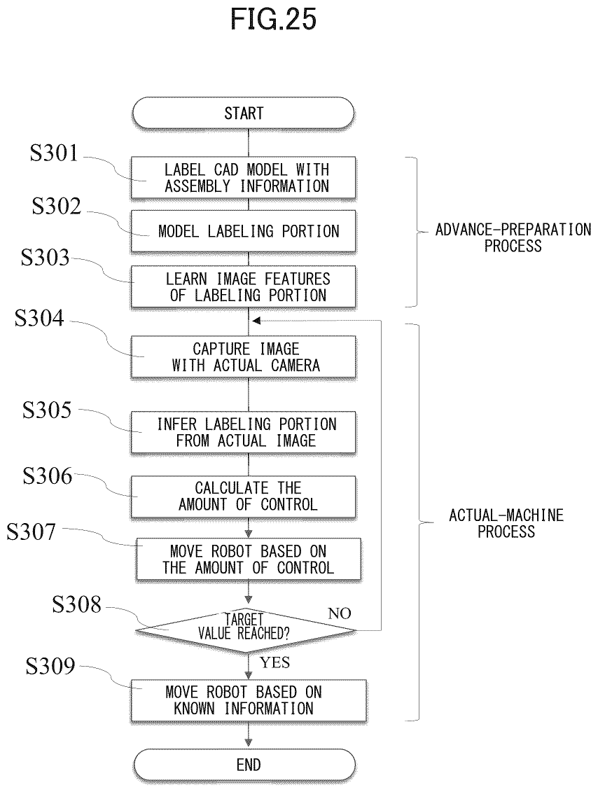

Next, a seventh embodiment will be described with reference to FIGS. 23 to 25. FIG. 23 is a control block diagram for illustrating control performed by using visual servo of the seventh embodiment. FIGS. 24A and 24B are diagrams for illustrating a method of creating image data that corresponds to target features of the seventh embodiment. FIG. 25 is a flowchart illustrating processes of assembly work performed by a robot apparatus of the seventh embodiment. Note that in the description for the seventh embodiment, a component identical to a component of the above-described various embodiments is given an identical symbol, and the description thereof will be omitted. In the present embodiment, the robot apparatus 100 performs the assembly work without using any assembly information, such as the table data TB described in the above-described embodiments, as table information. The control flow of the present embodiment is basically performed in accordance with the process flow illustrated in FIG. 4, but differs in the method of creating the trajectory performed in Step S106 of FIG. 4. In the present embodiment, the robot apparatus 100 is controlled by using the visual servo.

FIG. 23 is a control block diagram illustrating schematic control of the present embodiment. FIG. 23 is a diagram illustrating basic control blocks of known visual servo. In the present embodiment, image data of the CAD model 22 of the labeling portion 21 captured by the virtual camera 301 in the virtual space is inputted as target features. Hereinafter, a method of creating the image data that corresponds to the target features will be described with reference to FIGS. 24A-B.

In a case where the visual servo is used, the camera 300 serves as a moving camera mounted on the robot hand of the robot apparatus 100, as illustrated in FIG. 24A. FIG. 24A illustrates the state where the camera 300 serves as a moving camera mounted on the robot hand, in the virtual space. In FIG. 24A, a virtual camera 301 is disposed in the virtual space. That is, FIG. 24A illustrates a state where the relative positional relationship between the origin 319 of the camera coordinate system, the reference position 24 of the component 11, and the origin 23 of the coordinate system O that serves as a reference of the CAD model 22 that corresponds to the labeling portion 21 is set as known information. In this state, the component 11 can be assembled to the workpiece 10, based on the known relative positional relationship. In this state, the three-dimensional CAD model 22 of the work area, which is labeled so that the position of the work area is equal to the position of the labeling portion 21 of the CAD model 20 that represents the whole of the workpiece 10, is disposed, and the image of the CAD model 22 of the labeling portion 21 is captured by the virtual camera 301. As a result, as illustrated in FIG. 24B, the image data that represents the CAD model 22 in the virtual space can be obtained. The image data obtained in this manner is target features illustrated in FIG. 23.

In a case where the robot apparatus 100 is actually operated, the robot apparatus 100 is controlled in accordance with the control flowchart illustrated in FIG. 25. The control flow chart illustrated in FIG. 25 is performed mainly by the CPU 502 or the CPU 204. In FIG. 25, the processes in the steps S301 to S303 are the same as the above-described steps S101 to S103, but the processes in and after Step S304 are different from those of the flow of FIG. 4.

In Step S304, the CPU 204 causes the actual camera 300 to capture an image of the workpiece 10. In Step S305, the CPU 204 infers the labeling portion of the image data captured by the actual camera 300. In Step S306, the CPU 204 calculates the amount of control, based on the result of the inference. The calculation of the amount of control performed in Step S306 corresponds to work for calculating the difference between the target features and current features, as illustrated in FIG. 23. The result of the calculation is sent to a feature-base controller illustrated in FIG. 23, and is used as the amount of control for controlling the robot. Note that the control algorithm of the feature-base controller may be any one of various known methods based on a known feature-extraction method and including the image Jacobian-matrix computation.

In Step S307, the CPU 204 controls the robot apparatus 100 such that the image data captured by the actual camera 300 gradually looks like the image data that serves as the target features. In Step S308, the CPU 204 determines whether the difference between the target features and current features reaches a predetermined target value (threshold value). The target value may be a predetermined value, or may be a predetermined range. If the target value is reached (Step S308: Yes), then the CPU 204 proceeds to Step S309. If the target value is not reached (Step S308: No), then the CPU 204 returns to the start of Step S304 and repeats the control of the robot by using the visual servo.

If the target value is reached (Step S308: Yes), the actual robot apparatus 100 is in a state where the component 11 can be assembled to the workpiece 10, based on the known information as illustrated in FIGS. 24A-B. Thus, the CPU 204 moves the robot apparatus 100, based on the relative positional relationship between the origin 319, the reference position 24, and the origin 23, so that the reference position 24 becomes equal to the origin 23. With this operation, the assembly work is completed.

Note that in the present embodiment, the feature extraction method is performed by performing a method that detects the difference between images. In the present embodiment, the difference in features is determined by inputting, as the target features, the image data of the CAD model 22 of the labeling portion 21 captured by the virtual camera 301, and by inputting, as the current features, a result of inference to the labeling portion. However, the method of calculating the difference between images may be any one of various known methods of calculating the difference, such as the scale-invariant feature transformation (SIFT) or the accelerated KAZE (AKAZE), that calculate focused features from images and associate a feature of one image with a feature of another image (the features have a high degree of similarity to each other). Thus, an algorithm that performs the robot control by using at least two or more pieces of image data may be used as appropriate.

As described above, in the present embodiment, the position-and-posture information is obtained in the coordinate system O of the actual workpiece 10 without using the table data TB, so that the component 11 can be assembled to the workpiece 10. In addition, in the present embodiment, since the relative positional relationship for allowing the robot apparatus 100 to perform the assembly work is set in the virtual space, the load of the advance preparation can be further reduced. Thus, the automatic production system that performs the assembly work by using the robot apparatus 100 can be started in a short time. Note that although the above-described relative positional relationship is set, in the present embodiment, in the virtual space, the relative positional relationship may be set by using the actual robot apparatus 100. In this case, since the actual robot apparatus 100 is used, the accuracy of the assembly work can be increased.

### Feasibility of Other Embodiments

Note that in the description for the above-described first to fifth embodiments, the description has been made for the three-dimensional CAD model created in the virtual space, based on the CAD data. However, some embodiments of the present disclosure are not limited to this. For example, a two-dimensional model may be created.

In addition, although the description has been made, in the above-described first to fifth embodiments, for the case where the workpiece 10 and the work area (i.e., the labeling portion 21) of the workpiece 10 are modeled as the CAD model 20 and the CAD model 22, by using the design information such as CAD data, some embodiments of the present disclosure are not limited to this. That is, the component 11 may also be modeled as a CAD model, by using the design information such as CAD data. In this case, since the CAD model of the component 11 can be assembled virtually to the CAD model 22 of the labeling portion 21 in the virtual space, the trajectory of the robot arm 200 may be created by using the position and posture obtained in the virtual assembling. In another case, only an object, such as the component 11, held by the robot arm 200 (the component 11 may be referred to as a workpiece) may be modeled. In this case, if the workpiece 10 placed on the workpiece stand 12 or the like is positioned at a known position and has a known posture, the trajectory can be created by performing the model matching on the model of the component 11.

In addition, although the description has been made, in the above-described first to fifth embodiments, for the case where the image data of an actual image is created by causing the camera to capture the image of a workpiece, some embodiments of the present disclosure are not limited to this. For example, another component, such as a tactile sensor, an ultrasonic sensor, or a probe, may be used as long as the component can search the workpiece toward the search direction and create the search data, such as shape data that includes the shape data of the work area of the workpiece.

In addition, although the description has been made in the above-described first to fifth embodiments, as one example, for the case where the component 11 is assembled to the work area of the workpiece 10, some embodiments of the present disclosure are not limited to this. For example, in the work, adhesive, paint, oil, or the like may be applied onto a work area (i.e., an application area) of a workpiece. In another case, a component, such as a label or a seal, may be stuck to a work area (i.e., a sticking area) of a workpiece in the work. In another case, a tool, such as a driver or a cutter, may be abutted against a work area (i.e., a machining area) of a workpiece in the work.

In addition, although the description has been made, in the above-described first to seventh embodiments, for the case where a model of the workpiece or the work area (i.e., the labeling portion) is created in the virtual space by using the CAD data, some embodiments of the present disclosure are not limited to this. For example, a virtual model, such as a polygon model, may be created manually by a worker or a designer, in the virtual space. In addition, the design information is not limited to the CAD data. For example, the design information may be information in which the numerical value of the position and size of a workpiece is simply given.

In addition, although the description has been made, in the above-described first to seventh embodiments, for the case where the trajectory of the robot arm 200 is created in Step S106 or S207, some embodiments of the present disclosure are not limited to this. For example, in a case where a rough trajectory of the robot arm 200 is created, in advance, by a worker, a corrected trajectory into which the trajectory created by performing the teaching is corrected may be created in Step S106 or S207. That is, in creating the trajectory in Step S106 or S207, the trajectory may be newly created, or the corrected trajectory into which an existing trajectory is corrected may be created.

In addition, although the description has been made, in the above-described first to seventh embodiments, for the case where the machine learning is performed, in Step S103 or S203, by using a plurality of images including the CAD model 22 of the labeling portion 21, some embodiments of the present disclosure are not limited to this. That is, a plurality of images of the CAD model 22 (created in Step S102 or S202) virtually captured under different conditions (e.g., image capture angle and brightness) may be used as template images (target images). In this case, a labeling portion of an actual image may be inferred from the template images in the step S104 or the steps S204-1 and S204-2, and the template matching may be performed in Step S105 or S206.

In addition, although the description has been made, in the above-described first to seventh embodiments, for the case where the robot arm 200 of the robot apparatus 100 is a six-axis articulated manipulator, some embodiments of the present disclosure are not limited to this. For example, the robot arm 200 of the robot apparatus 100 may be a parallel link robot or a robot that includes a mechanism that translates three-dimensionally. That is, the robot arm 200 of the robot apparatus 100 may be a robot having any structure. In addition, some embodiments of the present disclosure can be applied to any machine that can automatically perform expansion and contraction motion, bending and stretching motion, up-and-down motion, right-and-left motion, pivot motion, or combination motion thereof, depending on the information data stored in a storage device of a control apparatus.

The present disclosure can also be achieved by providing a program, which performs one or more functions of the above-described embodiments, to a system or a device via a network or a storage medium, and by one or more processors, which are included in a computer of the system or the device, reading and executing the program. In addition, some embodiments of the present disclosure can also be achieved by using a circuit, such as an ASIC, which performs one or more functions.

Some embodiments of the present disclosure are not limited to the above-described embodiments, and may be variously modified within the technical concept of the present disclosure. In addition, two or more of the above-described plurality of embodiments may be combined with each other and embodied. In addition, the effects described in the embodiments are merely the most suitable effects produced by the present disclosure. Thus, the effects by the present disclosure are not limited to those described in the embodiments.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-204873,which was filed on Dec. 4, 2023, and Japanese Patent Application No. 2024-167897, which was filed on Sep. 26, 2024, which are hereby incorporated by reference herein in their entireties.

What is claimed is:

1. A robot system comprising:
a robot;
a search unit configured to search a work area of a workpiece where work is performed, and obtain search data that contains information on the work area;
at least one processor; and
at least one memory that is in communication with the at least one processor, wherein the at least one memory stores instructions for causing the at least one processor and the at least one memory to identify the work area and control the robot to perform work on the identified work area, based on information related to the work area, information on work related to the work area and performed on the workpiece, and the search data.

2. The robot system according to claim 1, wherein the information related to the work area is a model obtained by modeling the work area from design information used for designing the workpiece.

3. The robot system according to claim 1, wherein the information on work contains at least one of an assembly direction of a component, an assembly stroke for assembling the component, an assembly phase angle of the component, an insertion start position of the component, an insertion completion position of the component, and an insertion force for the component.

4. The robot system according to claim 3, wherein the information on work is set as table information.

5. The robot system according to claim 1, wherein the search data includes data obtained from a camera, a tactile sensor, an ultrasonic sensor, or a probe.

6. The robot system according to claim 2, wherein a coordinate system that indicates a position and posture of the model is set to the model, and
wherein the robot system is configured to
obtain information on a position and posture of the work area of the workpiece defined in the coordinate system of the model, by using the model and the information related to the work area obtained based on the search data, and
cause the robot to perform work on the work area of the workpiece, based on the information on the position and posture.

7. The robot system according to claim 6, wherein the robot includes a sensor configured to obtain information on force, and
wherein the robot system is configured to cause the robot to perform work on the work area of the workpiece, based on the information on the position and posture and the information on force applied to the robot.

8. The robot system according to claim 6, wherein the search unit includes an image capture apparatus disposed on the robot, and
wherein the robot system is configured to cause the robot to perform work on the work area of the workpiece, based on the information on the position and posture, a reference position of the image capture apparatus, and a reference position of a component moved by the robot.

9. The robot system according to claim 6, wherein the search unit includes an image capture apparatus, and
wherein the robot system is configured to obtain a trajectory of the robot for causing the robot to perform work on the workpiece, based on the information on the position and posture, the information on work, a coordinate system of a predetermined portion of the robot, a coordinate system of the image capture apparatus, and a coordinate system of the robot.

10. The robot system according to claim 2, wherein the search unit is configured to obtain the search data by probing the work area, with a search direction facing the work area, and
wherein the at least one memory further stores instructions for causing the at least one processor and the at least one memory to obtain learning-model information with learned features of the work area in a case where the model is searched from directions with a plurality of angles, and identify the work area, based on the learning-model information and the search data.

11. The robot system according to claim 10, wherein the search unit is an image capture apparatus configured to capture images in an image capture direction and obtain image data that contains features of the work area,
wherein the learning-model information is learning-model information learned features of the work area in a case where images of the model are captured from directions with a plurality of angles, and
wherein the at least one memory further stores instructions for causing the at least one processor and the at least one memory to identify the work area, based on the learning-model information and the image data captured by the image capture apparatus.

12. The robot system according to claim 11, wherein the at least one memory further stores instructions for causing the at least one processor and the at least one memory to:
create an inference image by inferring, based on the learning-model information, the work area from image data captured by the image capture apparatus, and
identify the work area of the image data by performing a matching process in which the model is matched with the inference image.

13. The robot system according to claim 12, wherein the learning-model information contains posture information on posture of the model, and
wherein the at least one memory further stores instructions for causing the at least one processor and the at least one memory to:
identify a matching area of image data by performing matching, based on the posture information, the model with the inference image, and
perform a matching process.

14. The robot system according to claim 12, wherein the image capture apparatus includes a plurality of cameras configured to perform three-dimensional measurement,
wherein the at least one memory further stores instructions for causing the at least one processor and the at least one memory to:
identify a matching area of the image data by performing matching, based on image data captured by each of the plurality of cameras, the model with the inference image, and
perform a matching process.

15. The robot system according to claim 12, wherein the at least one memory further stores instructions for causing the at least one processor and the at least one memory to:
perform a mask process on an area of the inference image other than a matching area where the model is matched, and
perform the matching process in which the model is matched with the inference image on which the mask process has been performed.

16. The robot system according to claim 2, wherein the model has work information on work performed on the work area, and
wherein the at least one memory further stores instructions for causing the at least one processor and the at least one memory to control the robot, based on the work information.

17. The robot system according to claim 16, wherein the work is assembly work in which a component held by the robot is assembled to the work area of the workpiece.

18. The robot system according to claim 1, wherein the at least one memory further stores instructions for causing the at least one processor and the at least one memory to, in a case where work is performed on the work area, control the robot, based on surrounding-model information on a surrounding model into which a surrounding object disposed around the workpiece is modeled, and the search data.

19. The robot system according to claim 18, wherein the at least one memory further stores instructions for causing the at least one processor and the at least one memory to, in a case where work is performed on the work area, determine, based on the surrounding-model information and the search data, a trajectory on which the robot and the surrounding object do not interfere with each other, and control the robot in accordance with the trajectory determined.

20. The robot system according to claim 1, wherein the at least one memory further stores instructions for causing the at least one processor and the at least one memory to, in a case where the work area is identified, cause a display apparatus to display the identified work area.

21. The robot system according to claim 2, further comprising an information processing apparatus configured to obtain the model.

22. A method of controlling a robot system including a robot, a search unit for probing a work area of a workpiece where work is performed, at least one processor, and at least one memory, the method comprising:
obtaining, by the search unit, search data that contains information on the work area; and
identifying, by the at least one processor and the at least one memory, the work area and controlling the robot to perform work on the identified work area, based on information related to the work area, information on work related to the work area and performed on the workpiece, and the search data.

23. A method comprising:
manufacturing products by using the robot system according to claim 1.

24. A computer-readable non-transitory recording medium storing computer-executable instructions that, when executed, cause a computer to perform a method comprising:
obtaining, by a search unit for probing a work area of a workpiece where work is performed, search data that contains information on the work area; and
identifying the work area and controlling a robot to perform work on the identified work area, based on information related to the work area, information on work related to the work area and performed on the workpiece, and the search data.
